(19) United States
(12) Patent Application Publication
(10) Pub. No.: US 2025/0124597 A1
(43) Pub. Date: Apr. 17, 2025

(54) Apparatus For Recognizing Object And Method Thereof

(71) Applicants: Hyundai Motor Company, Seoul (KR); Kia Corporation, Seoul (KR)

(72) Inventor: Nam Hyung Lee, Seoul (KR)

(21) Appl. No.: 18/640,072

(22) Filed: Apr. 19, 2024

(30) Foreign Application Priority Data
Oct. 13, 2023 (KR) 10-2023-0136878

(51) Int. Cl. G06T 7/73; G06T 7/33; G06V 10/46; G06V 20/56

(52) U.S. Cl. CPC G06T 7/74; G06T 7/337; G06V 10/46; G06V 20/588; G06T 2207/10028; G06T 2207/10044; G06T 2207/20221; G06T 2207/30256

(57) ABSTRACT

An object recognition apparatus includes a processor. The processor may determine a left line and a right line of a lane on which a vehicle is located, obtain a light detection and ranging (LIDAR) track corresponding to an external object, determine a LIDAR track state corresponding to a position of the LIDAR track relative to the left line or the right line, obtain a fusion track corresponding to the external object and obtained through at least two of a LIDAR, a radar, and a camera, determine a fusion track state corresponding to a position of the fusion track relative to the left line or the right line, move the fusion track in a direction determined based on the LIDAR track state and/or the fusion track state, and output a signal indicating the moved fusion track.

### CROSS-REFERENCE TO RELATED APPLICATION

This application claims the benefit of priority to Korean Patent Application No. 10-2023-0136878, filed in the Korean Intellectual Property Office on Oct. 13, 2023, the entire contents of which are incorporated herein by reference.

### TECHNICAL FIELD

The present disclosure relates to an object recognition apparatus and method, and more specifically, to a technology for obtaining position information of an identified track through sensors.

### BACKGROUND

Technology for detecting surrounding environments and distinguishing obstacles is required for an autonomous vehicle or a vehicle with activated driver assistance devices to adjust its driving path and avoid obstacles with minimal driver intervention.

An autonomous vehicles or a vehicle with activated driver assistance devices may obtain information about an external object by linking tracks corresponding to the same external object among tracks identified through a sensor, such as a light detection and ranging (LIDAR) device, tracks identified through a camera, and tracks identified through a radar. The autonomous vehicle or the vehicle with activated driver assistance devices may identify the position of an external object and identify an obstacle according to tracks obtained through a plurality of sensors including, for example, a LIDAR, a camera, and a radar.

### SUMMARY

The present disclosure has been made to solve the above-mentioned problems occurring in some implementations while advantages achieved by those implementations are maintained intact.

An aspect of the present disclosure provides an object recognition apparatus and method capable of improving the accuracy of the position of a fusion track by comparing a state corresponding to the position of the fusion track identified through a plurality of sensors with a state corresponding to the position of a LIDAR track identified through a LIDAR.

An aspect of the present disclosure provides an object recognition apparatus and method capable of reducing the frequency of false braking of an autonomous vehicle or a vehicle with activated driver assistance devices by improving the accuracy of the position of a fusion track.

An aspect of the present disclosure provides an object recognition apparatus and method capable of reducing the frequency of non-braking of an autonomous vehicle or a vehicle with an activated driving assistance device by comparing the state corresponding to the position of a fusion track identified through a plurality of sensors and the state corresponding to the position of a LIDAR track identified through a LIDAR.

An aspect of the present disclosure provides an object recognition apparatus and method capable of reducing the risk of accidents of an autonomous vehicle or a vehicle with an activated driving assistance device by comparing the state corresponding to the position of a fusion track identified through a plurality of sensors and the state corresponding to the position of a LIDAR track identified through a LIDAR.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an object recognition apparatus includes a camera, a LIDAR, a radar, and a processor.

According to one or more example embodiments, an apparatus may include: a camera; a light detection and ranging device (LIDAR); a radar; and a processor. The processor may be configured to: determine a left line and a right line of a lane on which a vehicle is located; obtain, via the LIDAR, a LIDAR track corresponding to an external object; determine, based on contour points representing the LIDAR track, a LIDAR track state, which corresponds to a position of the LIDAR track relative to one of the left line or the right line, as one of a first state, a second state, a third state, or a fourth state; obtain, via at least two of the LIDAR, the radar, and the camera, a fusion track corresponding to the external object; determine, based on a track box representing the fusion track, a fusion track state, which corresponds to a position of the fusion track relative to one of the left line or the right line, as one of the first state, the second state, the third state, or the fourth state; move, based on the LIDAR track state not matching the fusion track state, the fusion track in a direction determined based on at least one of the LIDAR track state or the fusion track state; and output a signal indicating the moved fusion track.

The processor may be further configured to: determine a first descriptor representing the left line and a second descriptor representing the right line; and determine a first point and a second point on the left line according to the LIDAR track and determine a third point and a fourth point on the right line according to the LIDAR track. The first point, the second point, the third point, and the fourth point may be determined based on: a longitudinal coordinate of a first contour point that is farthest, among the contour points representing the LIDAR track, from the vehicle in a longitudinal direction, a longitudinal coordinate of a second contour point that is closest, among the contour points representing the LIDAR track, to the vehicle in the longitudinal direction, the first descriptor, the second descriptor, and a specified distance. The processor may be configured to determine the LIDAR track state by determining the LIDAR track state based on at least one of a first straight line connecting the first point and the second point, a second straight line connecting the third point and the fourth point, or coordinates of the contour points. The processor may be configured to determine the fusion track state by determining the fusion track state based on at least one of the first straight line, the second straight line, or coordinates of four vertices of the track box.

The first point may include: a longitudinal coordinate that is farther from the vehicle among two longitudinal coordinates separated by the specified distance in the longitudinal direction from a longitudinal coordinate representing an average of the longitudinal coordinate of the first contour point and the longitudinal coordinate of the second contour point, and a lateral coordinate determined by applying the longitudinal coordinate farther from the vehicle into the first descriptor. The second point may include: a longitudinal coordinate that is closer to the vehicle among the two longitudinal coordinates, and a lateral coordinate determined by applying the longitudinal coordinate that is closer to the vehicle into the first descriptor. The third point may include: the longitudinal coordinate that is farther from the vehicle among the two longitudinal coordinates, and a lateral coordinate determined by applying the longitudinal coordinate that is farther from the vehicle into the second descriptor. The fourth point may include: the longitudinal coordinate that is closer to the vehicle among the two longitudinal coordinates, and a lateral coordinate determined by applying the longitudinal coordinate that is closer to the vehicle into the second descriptor.

The processor may be configured to determine the LIDAR track state by: determining the LIDAR track state further based on at least one of: at least one direction in which at least part of the contour points are located among a left side and a right side divided by the first straight line, or at least one direction in which at least part of the contour points are located among a left side and a right side divided by the second straight line. The processor may be configured to determine the fusion track state by: determining the fusion track state based on at least one of: at least one direction in which at least part of the four vertices are located among the left side and the right side divided by the first straight line, or at least one direction in which at least part of the four vertices are located among the left side and the right side divided by the second straight line.

The processor may be further configured to: determine a third descriptor representing the first straight line and a fourth descriptor representing the second straight line. The processor may be configured to determine the LIDAR track state by determining the LIDAR track state based on at least one of: a first direction includes at least one direction in which at least part of the contour points are located among left and right sides separated by the left line. The first direction may be determined based on signs of values determined by applying the coordinates of the contour points into the third descriptor, and a second direction includes at least one direction in which at least part of the contour points are located among left and right sides separated by the right line. The second direction may be determined based on signs of values determined by applying the coordinates of the contour points into the fourth descriptor. The processor may be configured to determine the fusion track state by determining the fusion track state based on at least one of: a third direction includes at least one direction in which at least part of the four vertices are located among left and right sides separated by the left line. The third direction may be determined based on signs of values determined by applying the coordinates of the four vertices into the third descriptor, and a fourth direction at least one direction in which at least part of the four vertices are located among left and right sides separated by the right line. The fourth direction may be determined based on signs of values determined by applying the coordinates of the four vertices into the fourth descriptor.

The processor may be configured to move the fusion track by, based on the LIDAR track state corresponding to the position of the LIDAR track relative to the left line not matching the fusion track state corresponding to the position of the fusion track relative to the left line: determining a first distance between a fifth point located on the first straight line and a rightmost vertex of the four vertices; determining a second distance between a sixth point located on the first straight line and a rightmost contour point among the contour points; and moving the fusion track by a sum of the first distance and the second distance. A longitudinal coordinate of the fifth point may be identical to a longitudinal coordinate of the rightmost vertex. A longitudinal coordinate of the sixth point may be identical to a longitudinal coordinate of the rightmost contour point.

The processor may be configured to move the fusion track by, based on the LIDAR track state corresponding to the position of the LIDAR track relative to the right line not matching the fusion track state corresponding to the position of the fusion track relative to the right line: determining a third distance between a seventh point located on the second straight line and a leftmost vertex of the four vertices; determining a fourth distance between an eighth point located on the second straight line and a leftmost contour point among the contour points; and moving the fusion track by a sum of the third distance and the fourth distance. A longitudinal coordinate of the seventh point may be identical to a longitudinal coordinate of the leftmost vertex. A longitudinal coordinate of the eighth point may be identical to a longitudinal coordinate of the leftmost contour point.

The processor may be configured to determine the LIDAR track state by performing one of: determining the LIDAR track state to be the first state based on determining that part of the contour points are located to left of the left line, other part of the contour points are located to right of the left line, and the contour points are located to left of the right line; determining the LIDAR track state to be the second state based on determining that the contour points are located to right of the left line, part of the contour points are located to left of the right line, other part of the contour points are located to right of the right line; determining the LIDAR track state to be the third state based on determining that the contour points are located to left of the left line and the contour points are located to left of the right line; or determining the LIDAR track state to be the fourth state based on determining that the contour points are located to right of the left line and the contour points are located to right of the right line.

The processor may be configured to determine the fusion track state by performing one of: determining the fusion track state to be the first state based on identifying that part of the four vertices are located to left of the left line, other part of the four vertices are located to right of the left line, and the four vertices are located to left of the right line; determining the fusion track state to be the second state based on identifying that the four vertices are located to right of the left line, part of the four vertices are located to left of the right line, and other part of the four vertices are located to right of the right line; determining the fusion track state to be the third state based on identifying that the four vertices are located to left of the left line and the four vertices are located to left of the right line; or determining the fusion track state to be the fourth state based on identifying that the four vertices are located to right of the left line and the four vertices are located to right of the right line.

The processor may be further configured to perform at least one of: determining the LIDAR track state to be a fifth state based on determining that the contour points are located to right of the left line and the contour points are located to left of the right line; determining the LIDAR track state to be a sixth state based on determining that part of the contour points are located to left of the left line, other part of the contour points are located to right of the left line, part of the contour points are located to left of the right line, and other part of the contour points are located to right of the right line; determining the fusion track state to be the fifth state based on identifying that the four vertices are located to right of the left line and the four vertices are located to left of the right line; or determining the fusion track state to be the sixth state based on determining that part of the four vertices are located to left of the left line, other part of the four vertices are located to right of the left line, part of the four vertices are located to left of the right line, and other part of the four vertices are located to right of the right line.

The processor may be further configured to perform one of: moving, based on the LIDAR track state being the first state and the fusion track state being the third state, the fusion track in a direction closer to the left line by a first distance determined based on at least one of a rightmost vertex among four vertices of the track box, or a rightmost contour point of the contour points; and moving, based on the LIDAR track state being the third state and the fusion track state being the first state, the fusion track in a direction away from the left line by the first distance.

The processor may be further configured to perform one of: moving the fusion track in a direction closer to the right line by a first distance determined based on at least one of a leftmost vertex of four vertices of the track box, or a leftmost contour point of the contour points, based on the LIDAR track state being the second state and the fusion track state being the fourth state; and moving the fusion track in a direction away from the right line by the first distance based on the LIDAR track state being the fourth state and the fusion track state being the second state.

The processor may be configured to perform one of: determining, based on a portion of an image obtained through the camera, at least one of the first descriptor or the second descriptor; or determining, based on at least one of a yaw rate of the vehicle or a steering angle sensor angle, at least one of the first descriptor or the second descriptor.

According to one or more example embodiments, a method performed by a processor may include: determining a left line and a right line of a lane on which a vehicle is located; obtaining, via a light detection and ranging device (LIDAR), a LIDAR track corresponding to an external object; determining, based on contour points representing the LIDAR track, a LIDAR track state, which corresponds to a position of the LIDAR track relative to one of the left line or the right line, as one of a first state, a second state, a third state, or a fourth state; obtaining, via at least two of the LIDAR, a radar, and a camera, a fusion track corresponding to the external object; determining, based on a track box representing the fusion track, a fusion track state, which corresponds to a position of the fusion track relative to one of the left line or the right line, as one of the first state, the second state, the third state, or the fourth state; moving, based on the LIDAR track state not matching the fusion track state, the fusion track in a direction determined based on at least one of the LIDAR track state or the fusion track state; and outputting a signal indicating the moved fusion track.

The method may further include determining a first descriptor representing the left line and a second descriptor representing the right line. Determining the LIDAR track state may include: determining a first point and a second point on the left line according to the LIDAR track and determining a third point and a fourth point on the right line according to the LIDAR track. Determining the first point, the second point, the third point, and the fourth point may be based on: a longitudinal coordinate of a first contour point that is farthest, among the contour points representing the LIDAR track, from the vehicle in a longitudinal direction, a longitudinal coordinate of a second contour point that is closest, among the contour points representing the LIDAR track, to the vehicle in the longitudinal direction, the first descriptor, the second descriptor, and a specified distance. The method may further include determining the LIDAR track state based on at least one of a first straight line connecting the first point and the second point, a second straight line connecting the third point and the fourth point, or coordinates of the contour points. Determining the fusion track state may include determining of the fusion track state based on at least one of the first straight line, the second straight line, or coordinates of four vertices of the track box.

The first point may include: a longitudinal coordinate that farther from the vehicle among two longitudinal coordinates separated by the specified distance in the longitudinal direction from a longitudinal coordinate representing an average of the longitudinal coordinate of the first contour point and the longitudinal coordinate of the second contour point, and a lateral coordinate determined by applying the longitudinal coordinate farther from the vehicle into the first descriptor. The second point may include: a longitudinal coordinate that is closer to the vehicle among the two longitudinal coordinates, and a lateral coordinate determined by applying the longitudinal coordinate that is closer to the vehicle into the first descriptor. The third point may include: the longitudinal coordinate that is farther from the vehicle among the two longitudinal coordinates, and a lateral coordinate determined by applying the longitudinal coordinate that is farther from the vehicle into the second descriptor. The fourth point may include: the longitudinal coordinate that is closer to the vehicle among the two longitudinal coordinates, and a lateral coordinate determined by applying the longitudinal coordinate that is closer to the vehicle into the second descriptor.

Determining the LIDAR track state may include: determining the LIDAR track state further based on at least one of: at least one direction in which at least part of the contour points are located among a left side and a right side divided by the first straight line, or at least one direction in which at least part of the contour points are located among a left side and a right side divided by the second straight line. Determining the fusion track state may include: determining the fusion track state based on at least one of: at least one direction in which at least part of the four vertices are located among the left side and the right side divided by the first straight line, or at least one direction in which at least part of the four vertices are located among the left side and the right side divided by the second straight line.

The method may further include: determining a third descriptor representing the first straight line and a fourth descriptor representing the second straight line. Determining the LIDAR track state may include determining of the LIDAR track state based on at least one of: a first direction includes at least one direction in which at least part of the contour points are located among left and right sides separated by the left line. The first direction may be determined based on signs of values determined by applying the coordinates of the contour points into the third descriptor, and a second direction includes at least one direction in which at least part of the contour points are located among left and right sides separated by the right line. The second direction may be determined based on signs of values determined by applying the coordinates of the contour points into the fourth descriptor. Determining the fusion track state may include determining the fusion track state based on at least one of: a third direction includes at least one direction in which at least part of the four vertices are located among left and right sides separated by the left line, wherein the third direction is determined based on signs of values determined by applying the coordinates of the four vertices into the third descriptor, or a fourth direction at least one direction in which at least part of the four vertices are located among left and right sides separated by the right line. The fourth direction may be determined based on signs of values determined by applying the coordinates of the four vertices into the fourth descriptor.

Moving the fusion track may include, based on the LIDAR track state corresponding to the position of the LIDAR track relative to the left line not matching the fusion track state corresponding to the position of the fusion track relative to the left line: determining a first distance between a fifth point located on the first straight line and a rightmost vertex of the four vertices; determining a second distance between a sixth point located on the first straight line and a rightmost contour point among the contour points; and moving the fusion track by a sum of the first distance and the second distance. A longitudinal coordinate of the fifth point may be identical to a longitudinal coordinate of the rightmost vertex. A longitudinal coordinate of the sixth point may be identical to a longitudinal coordinate of the rightmost contour point.

Moving the fusion track may include, based on the LIDAR track state corresponding to the position of the LIDAR track with respect to the right line not matching the fusion track state corresponding to the position of the fusion track relative to the right line: determining a third distance between a seventh point located on the second straight line and a leftmost vertex of the four vertices; determining a fourth distance between an eighth point located on the second straight line and a leftmost contour point among the contour points; and moving the fusion track by a sum of the third distance and the fourth distance. A longitudinal coordinate of the seventh point may be identical to a longitudinal coordinate of the leftmost vertex. A longitudinal coordinate of the eighth point may be identical to a longitudinal coordinate of the leftmost contour point.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of an object recognition apparatus;

FIG. 2 shows the flowchart of operation of an object recognition apparatus for moving a fusion track based on a state corresponding to the position of a LIDAR track and state corresponding to the position of a fusion track in an object recognition apparatus or an object recognition method;

FIG. 3 shows examples of a straight line corresponding to a left line and a straight line corresponding to a right line in an object recognition apparatus or an object recognition method;

FIG. 4 shows examples of a state corresponding to the position of a fusion track and a state corresponding to the position of a LIDAR track in an object recognition apparatus or an object recognition method;

FIG. 5 shows a table showing a state corresponding to the position of a fusion track and a state corresponding to the position of a LIDAR track in an object recognition apparatus or an object recognition method;

FIG. 6 shows a case in which a state corresponding to the position of a fusion track does not match a state corresponding to the position of a LIDAR track in an object recognition apparatus or an object recognition method;

FIG. 7 shows an example of a distance a fusion track has moved in an object recognition apparatus or an object recognition method;

FIG. 8 shows a flowchart of operation of an object recognition apparatus for moving a fusion track in an object recognition apparatus or an object recognition method;

FIG. 9 shows an example of accuracy improvement performed based on movement of a fusion track in an object recognition apparatus or an object recognition method; and

FIG. 10 shows a computing system related to an object recognition apparatus and an object recognition method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiment of the present disclosure, a detailed description of well-known features or functions will be ruled out in order not to unnecessarily obscure the gist of the present disclosure.

In describing the components of the example embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

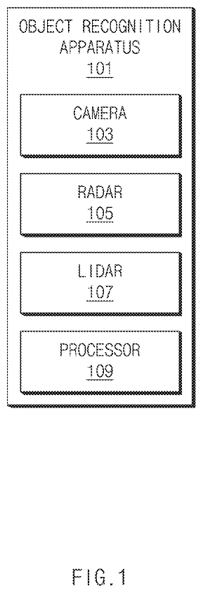

Hereinafter, one or more example embodiments of the present disclosure will be described in detail with reference to FIGS. 1 to 10.

FIG. 1 is a block diagram showing a configuration of an object recognition apparatus.

Referring to FIG. 1, an object recognition apparatus 101 may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a camera 103, a radar 105, a LIDAR 107, and a processor 109.

The processor 109 of the object recognition apparatus 101 may identify a track corresponding to an external object based on the camera 103, the radar 105, or the LIDAR 107. The processor 109 of the object recognition apparatus 101 may identify a track corresponding to an external object. A track may refer to an object in a tracking operation of identifying whether an external object identified in a specific frame is the same object as an external object included in at least one frame previously acquired before the specific frame. An identifier may be assigned to the track. The track may refer to a sensor-based output unit for tracking an identified external object over time.

The processor 109 of the object recognition apparatus 101 may identify a camera track corresponding to an external object based on a portion of an image acquired through the camera 103. The processor 109 of the object recognition apparatus 101 may identify a radar track corresponding to an external object based on at least one radar point acquired through the radar 105. The processor 109 of the object recognition apparatus 101 may identify a LIDAR track corresponding to an external object based on at least one LIDAR point acquired through the LIDAR 107.

The processor 109 of the object recognition apparatus 101 may identify a fusion track based on at least two tracks which correspond to the same external object among the camera track, the radar track, and the LIDAR track. For example, the processor 109 of the object recognition apparatus 101 may identify a fusion track corresponding to an external object based on the camera track and the radar track.

It should be noted that the accuracy of the position of a fusion track may be lower than the accuracy of the position of a LIDAR track representing an external object corresponding to the fusion track. Therefore, the processor 109 of the object recognition apparatus 101 may improve the accuracy of the position of the fusion track by moving the fusion track when false braking or non-braking of a host vehicle is expected due to a difference in position between the fusion track and the LIDAR track.

However, when moving the fusion track, the processor 109 of the object recognition apparatus 101 is required to perform computations, so that the processor 109 of the object recognition apparatus 101 may move the fusion track only when the false braking or non-braking of the host vehicle is expected, to improve computational efficiency. The false braking of the host vehicle may mean braking performed even though there is no need to brake the host vehicle. The non-braking of the host vehicle may mean braking that is not performed even though there is a need to brake the host vehicle.

The processor 109 of the object recognition apparatus 101 may identify when the false braking or non-braking of the host vehicle is expected due to a difference between the position of the fusion track and the position of the LIDAR track based on a state corresponding to the position of the fusion track with respect to the left or right line of the host vehicle, and a state corresponding to the position of the LIDAR track with respect to the left or right line of the host vehicle.

The processor 109 of the object recognition apparatus 101 may identify the left line and the right line of a lane on which the host vehicle is located. The processor 109 of the object recognition apparatus 101 may identify a first descriptor (e.g., a first function, a first mathematical function, etc.) representing the left line and a second descriptor (e.g., a second function, a second mathematical function, etc.) representing the right line.

The processor 109 of the object recognition apparatus 101 may identify a LIDAR track obtained through the LIDAR 107 and corresponding to an external object (e.g., a preceding vehicle).

The processor 109 of the object recognition apparatus 101 may identify a state corresponding to the position of the LIDAR track with respect to the left line or the right line as one of a first state, a second state, a third state, and a fourth state, based on contour points representing the LIDAR track. The state corresponding to the position of the LIDAR track may indicate in which direction (e.g., left or right) the contour points representing the LIDAR track with respect to the left line is located relative to the left line, or indicate in which direction (e.g., left or right) the contour points representing the LIDAR track with respect to the right line is located relative to the right line.

For example, the processor 109 of the object recognition apparatus 101 may identify first and second points on the left line according to the LIDAR track, and third and fourth points on the right line according to the LIDAR track based on the longitudinal coordinates of a first contour point, which is the contour point furthest from the host vehicle in a longitudinal direction among the contour points representing the LIDAR track, the longitudinal coordinates of a second contour point, which is the contour point closest to the host vehicle in the longitudinal direction among the contour points, the first descriptor (e.g., the first function), the second descriptor (e.g., the second function), and a specified distance.

The processor 109 of the object recognition apparatus 101 may identify the state corresponding to the position of the LIDAR track, based on at least one of a first straight line connecting the first point and the second point, a second straight line connecting the third point and the fourth point, or the coordinates of the contour points, or any combination thereof.

The processor 109 of the object recognition apparatus 101 may identify a fusion track obtained through at least two sensors among the LIDAR, the radar, and the camera and corresponding to an external object (e.g., a preceding vehicle).

The processor 109 of the object recognition apparatus 101 may identify a state corresponding to the position of a fusion track with respect to the left line or the right line, as one of the first state, the second state, the third state, and the fourth state, based on at least one of the first straight line, the second straight line, or the coordinates of the four vertices of a track box, or any combination thereof. The state corresponding to the position of the fusion track may indicate in which direction (e.g., left or right) the contour points representing the fusion track with respect to the left line is located relative to the left line, or indicate in which direction (e.g., left or right) the contour points representing the fusion track with respect to the right line is located relative to the right line.

If the state corresponding to the position of the LIDAR track does not match the state corresponding to the position of the fusion track, the processor 109 of the object recognition apparatus 101 may move the fusion track in a direction identified based on at least one of the state corresponding to the position of the LIDAR track, or the state corresponding to the position of the fusion track, or any combination thereof. The object recognition apparatus 101 may output a signal indicating the moved fusion track.

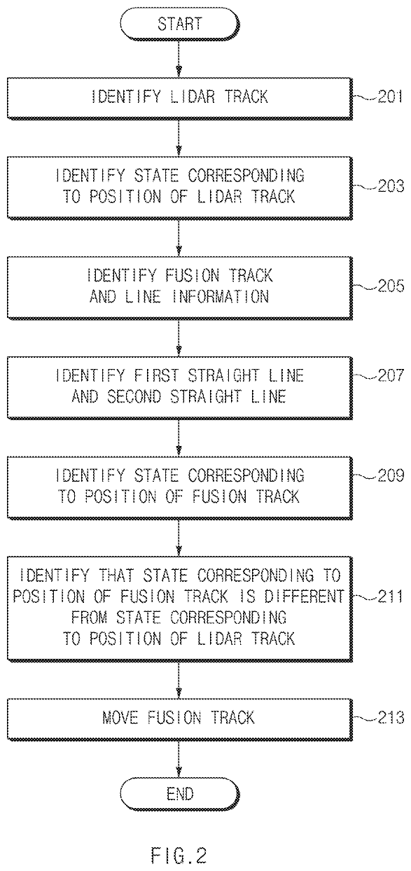

FIG. 2 shows the flowchart of operation of an object recognition apparatus for moving a fusion track based on a state corresponding to the position of a LIDAR track and a state corresponding to the position of a fusion track in an object recognition apparatus or an object recognition method.

Hereinafter, it is assumed that the object recognition apparatus 101 of FIG. 1 performs the process of FIG. 2. Additionally, in the description of FIG. 2, operations described as being performed by the object recognition apparatus may be understood as being controlled by the processor 109 of the object recognition apparatus 101.

Referring to FIG. 2, in a first operation 201, the processor of the object recognition apparatus may identify a LIDAR track. The LIDAR tracks may be identified through a front corner LIDAR (FCL). The LIDAR track may correspond to an external object (e.g., a preceding vehicle).

In a second operation 203, the processor of the object recognition apparatus may identify a state corresponding to the position of the LIDAR track. The state corresponding to the position of the LIDAR track may be identified based on a direction in which part of contour points representing the LIDAR track are located relative to the left line, and a direction in which part of the contour points are located relative to the right line.

For example, when the part of the contour points representing the LIDAR track are located to the left of a specific line (e.g., a left line or a right line), and the other part of the contour points are located to the right of the specific line, the processor of the object recognition apparatus may identify that the LIDAR track is intruding on the specific line.

For example, when all of the contour points representing the LIDAR track are located only on the left side of the specific line, or when all of the contour points are located only on the right side of the specific line, the processor of the object recognition apparatus may identify that the LIDAR track is located on the right or left side of the specific line, and the LIDAR track does not intrude on the specific line.

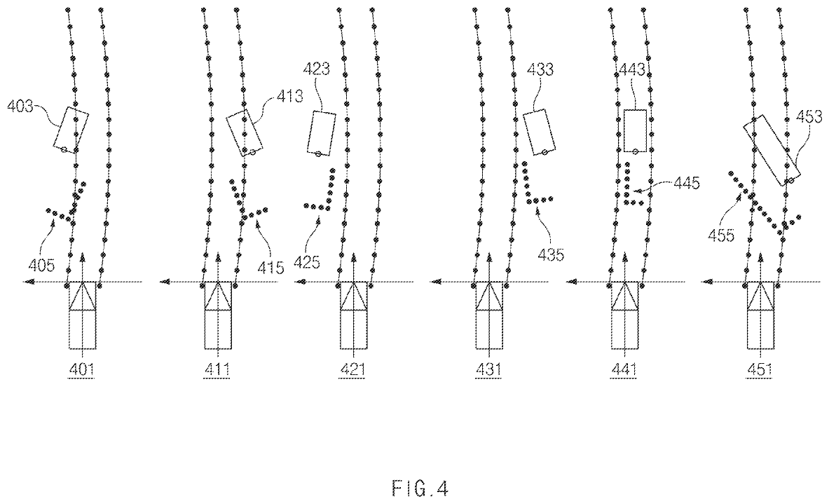

Hereinafter, a method of identifying a state corresponding to the position of a LIDAR track will be described in detail with reference to FIG. 4.

In a third operation 205, the processor of the object recognition apparatus may identify a fusion track and line information. The fusion track may be identified based on a front camera (FC). The fusion track may represent vehicle dynamics information.

In a fourth operation 207, the processor of the object recognition apparatus may identify a first straight line and a second straight line. The first straight line may be identified based on the LIDAR track and the left line. The second straight line may be identified based on the LIDAR track and the right line. The first straight line may connect a first point and a second point on the left line according to the longitudinal position of the LIDAR track. The second straight line may connect a third point and a fourth point on the right line according to the longitudinal position of the LIDAR track.

In a fifth operation 209, the processor of the object recognition apparatus may identify a state corresponding to the position of the fusion track. The state corresponding to the position of the fusion track may be identified based on a direction in which the four vertices of a track box representing the fusion track are located relative to the left line, and a direction in which the four vertices of the track box are located relative to the right line.

For example, when part of the four vertices are located to the left of a specific line (e.g., a left line or a right line) and the other part of the four vertices are located to the right of the specific line, the processor of the object recognition apparatus may identify that the fusion track is intruding on the specific line.

For example, when all four vertices are located only on the left side of the specific line, or all four vertices are located only on the right side of the specific line, the processor of the object recognition apparatus may identify that the fusion track is located on the left side or the right side of the specific line and the fusion track is not intruding on the specific line.

Hereinafter, a method of identifying a state corresponding to the position of a fusion track will be described in detail with reference to FIG. 4.

In a sixth operation 211, the processor of the object recognition apparatus may identify whether a state corresponding to the position of the LIDAR track is different from a state corresponding to the position of the fusion track. When the state corresponding to the position of the LIDAR track is different from the state corresponding to the position of the fusion track, a false braking or non-braking of a host vehicle may be expected due to the difference in position between the fusion track and the LIDAR track.

In a seventh operation 213, the processor of the object recognition apparatus may move the fusion track. The processor of the object recognition apparatus may move the fusion track in a lateral direction based on the difference between the state corresponding to the position of the LIDAR track and the state corresponding to the position of the fusion track, thereby improving the accuracy of the position of the fusion track after movement, compared to the accuracy of the position of the fusion track before movement.

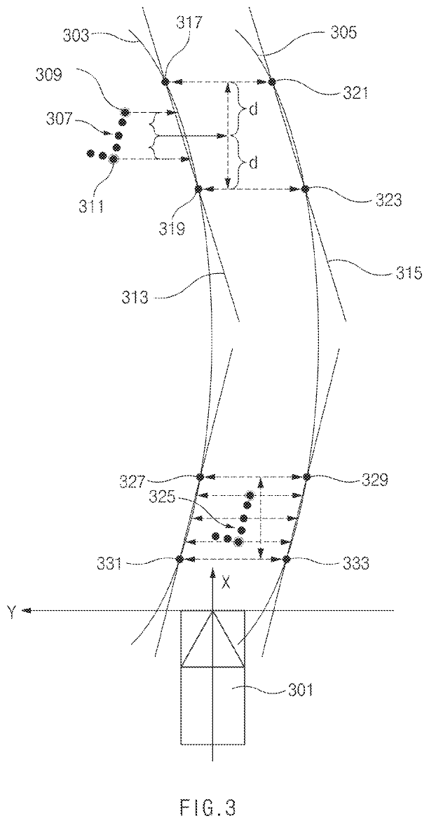

FIG. 3 shows examples of a straight line corresponding to a left line and a straight line corresponding to a right line in an object recognition apparatus or an object recognition method.

Referring to FIG. 3, the processor of the object recognition apparatus may identify a first descriptor (e.g., a first function) representing a left line 303 of a host vehicle 301 and a second descriptor (e.g., a second function) representing a right line 305.

A first LIDAR track 307 may include contour points representing a first external object (e.g., a first preceding vehicle). A first contour point 309 may be the point furthest from the host vehicle 301 in the longitudinal direction among the contour points representing the first LIDAR track 307. A second contour point 311 may be the closest point to the host vehicle 301 in the longitudinal direction among the contour points representing the first LIDAR track 307.

A first point 317 and a second point 319 may be identified according to the first LIDAR track 307 and located on the left line. A third point 321 and a fourth point 323 may be identified according to the first LIDAR track 307 and may be located on the right line. A first straight line 313 may be a straight line connecting the first point 317 and the second point 319. A second straight line 315 may be a straight line connecting the third point 321 and the fourth point 323.

A second LIDAR track 325 may include contour points representing a second external object (e.g., a second preceding vehicle). A fifth point 327 and a sixth point 331 may be identified according to the second LIDAR track 325 and may be located on the left line. A seventh point 329 and an eighth point 333 may be identified according to the second LIDAR track 325 and may be located on the right line.

Referring to FIG. 3, the processor of the object recognition apparatus may identify the first straight line 313 corresponding to the left line and the second straight line 315 corresponding to the right line, based on the longitudinal position of the first LIDAR track 307.

For example, the first point 317 may include a longitudinal coordinate which is farther from the host vehicle 301 among two longitudinal coordinates separated by a specified distance (e.g., “d”) in the longitudinal direction from a longitudinal coordinate representing the average of the longitudinal coordinate of the first contour point 309 and the longitudinal coordinate of the second contour point 311, and a lateral coordinate identified by substituting the longitudinal coordinate farther from the host vehicle 301 into a first descriptor (e.g., a first function).

For example, the second point 319 may include a longitudinal coordinate which is closer from the host vehicle 301 among two longitudinal coordinates separated by the specified distance (e.g., “d”) in the longitudinal direction from the longitudinal coordinate representing the average of the longitudinal coordinate of the first contour point 309 and the longitudinal coordinate of the second contour point 311, and a lateral coordinate identified by substituting the longitudinal coordinate closer from the host vehicle 301 into the first descriptor (e.g., the first function).

For example, the third point 321 may include a longitudinal coordinate representing the average of the longitudinal coordinate of the first contour point 309 and the longitudinal coordinate of the second contour point 311, and a longitudinal coordinate which is farther from the host vehicle 301 among two longitudinal coordinates separated by a specified distance (e.g., “d”) in the longitudinal direction from a longitudinal coordinate representing the average of the longitudinal coordinate of the first contour point 309 and the longitudinal coordinate of the second contour point 311, and a lateral coordinate identified by substituting the longitudinal coordinate farther from the host vehicle 301 into a second descriptor (e.g., a second function).

For example, the fourth point 323 may include the longitudinal coordinate which is closer from the host vehicle 301 among two longitudinal coordinates separated by the specified distance (e.g., “d”) in the longitudinal direction from the longitudinal coordinate representing the average of the longitudinal coordinate of the first contour point 309 and the longitudinal coordinate of the second contour point 311, and a lateral coordinate identified by substituting the longitudinal coordinate closer from the host vehicle 301 into the second descriptor (e.g., the second function).

The first straight line 313 may be represented as a third descriptor (e.g., a third function) that is a function of a straight line passing through the first point 317 and the second point 319. The second straight line 315 may be represented as a fourth descriptor (e.g., a fourth function), which may be, for example, a function (e.g., a mathematical function) of a straight line passing through the third point 321 and the fourth point 323.

The processor of the object recognition apparatus may identify the first descriptor (e.g., the first function) and the second descriptor (e.g., the second function) based on a portion of an image identified through a camera. The processor of the object recognition apparatus may identify the first descriptor (e.g., the first function) and the second descriptor (e.g., the second function) based on at least one of a yaw rate of the host vehicle 301, or a steering angle sensor (SAS) angle, or any combination thereof. The yaw rate may represent the rotation angle of a vehicle body. The SAS angle may represent the rotation angle of a wheel identified through a steering sensor. The first descriptor (e.g., the first function) may be identified as an nth-order function (e.g., a quadratic function). The second function may be identified as an nth-order function (e.g., a quadratic function).

The third descriptor (e.g., the third function) representing the first straight line 313 may be identified by Equation 1. x₁ may represent the longitudinal coordinates of the first point 317, y₁ may represent the lateral coordinates of the first point 317, x₂ may represent the longitudinal coordinates of the second point 319, and y₂ may represent the lateral coordinates of the second point 319.

$$( {y}_{1} - {y}_{2} ) x + ( {x}_{2} - {x}_{1} ) y + ( {x}_{1} \cdot {y}_{2} - {x}_{2} \cdot {y}_{1} ) = 0 \qquad [ Equation 1 ]$$

The fourth descriptor (e.g., the fourth function) representing the second straight line 315 may be identified by Equation 2. x₃ may represent the longitudinal coordinates of the third point 321, y₃ may represent the lateral coordinates of the third point 321, x₄ may represent the longitudinal coordinates of the fourth point 323, and y₄ may represent the lateral coordinates of the fourth point 323.

$$( {y}_{3} - {y}_{4} ) x + ( {x}_{4} - {x}_{3} ) y + ( {x}_{3} \cdot {y}_{4} - {x}_{4} \cdot {y}_{3} ) = 0 \qquad [ Equation 2 ]$$

Straight lines for identifying the state corresponding to the position of the first LIDAR track 307 located on the left side of the left line and the left side of the right line may be identified as the first straight line 313 and the second straight line 315.

Straight lines for identifying the state corresponding to the position of the second LIDAR track 325 located on the right side of the left line and the left line of the right line may be identified as a third straight line connecting the fifth point 327 and the sixth point 331 and a fourth straight line connecting the seventh point 329 and the eighth point 333.

FIG. 4 shows examples of a state corresponding to the position of a fusion track and a state corresponding to the position of a LIDAR track in an object recognition apparatus or an object recognition method.

Referring to FIG. 4, in a first situation 401, a first fusion track 403 may be in a first state. In the first situation 401, a first LIDAR track 405 may be in a first state. In a second situation 411, a second fusion track 413 may be in a second state. In the second situation 411, a second LIDAR track 415 may be in the second state. In a third situation 421, a third fusion rack 423 may be in a third state. In the third situation 421, a third LIDAR track 425 may be in the third state. In a fourth situation 431, a fourth fusion track 433 may be in a fourth state. In the fourth situation 431, a fourth LIDAR track 435 may be in the fourth state. In a fifth situation 441, a fifth LIDAR track 445 may be in a fifth state. In the fifth situation 441, a fifth fusion track 443 may be in the fifth state. In a sixth situation 451, a sixth fusion track 453 may be in a sixth state. In the sixth situation 451, a sixth LIDAR track 455 may be in the sixth state.

The processor of the object recognition apparatus may identify a state corresponding to the position of a LIDAR track with respect to the left line or the right line as one of a first state, a second state, a third state, a fourth state, a fifth state, and a sixth state, based on at least one direction in which all or part of contour points are located among the left and right sides divided by a first straight line, and at least one direction in which all or part of the contour points are located among the left and right sides divided by a second straight line.

The processor of the object recognition apparatus may identify a state corresponding to the position of a fusion track with respect to the left line or the right line as one of a first state, a second state, a third state, a fourth state, a fifth state, and a sixth state, based on at least one direction in which all or part of four vertices are located among the left and right sides divided by a first straight line, and at least one direction in which all or part of the four vertices are located among the left and right sides divided by a second straight line.

The first LIDAR track 405 in the first state and the first fusion track 403 in the first state may intrude on the left line. The first state may be referred to as a left intrusion state, but the present disclosure may not be limited thereto.

The second LIDAR track 415 in the second state and the second fusion track 413 in the second state may intrude on the right line. The second state may be referred to as a right intrusion state, but the present disclosure may not be limited thereto.

The third LIDAR track 425 in the third state and the third fusion track 423 in the third state may be located on the left side of the left line. The third state may be referred to as a left non-intrusion state, but the present disclosure may not be limited thereto.

The fourth LIDAR track 435 in the fourth state and the fourth fusion track 433 in the fourth state may be located on the right side of the right line. The fourth state may be referred to as a right non-intrusion state, but the present disclosure may not be limited thereto.

The fifth LIDAR track 445 in the fifth state and the fifth fusion track 443 in the fifth state may be located on the right side of the left line and on the left side of the right line. The fifth state may be referred to as a total inclusion state or a total ego lane state, but the present disclosure may not be limited thereto.

The sixth LIDAR track 455 in the sixth state and the sixth fusion track 453 in the sixth state may intrude on the left line and may intrude on the right line. The sixth state may be referred to as a stretch on ego lane state, but the present disclosure may not be limited thereto.

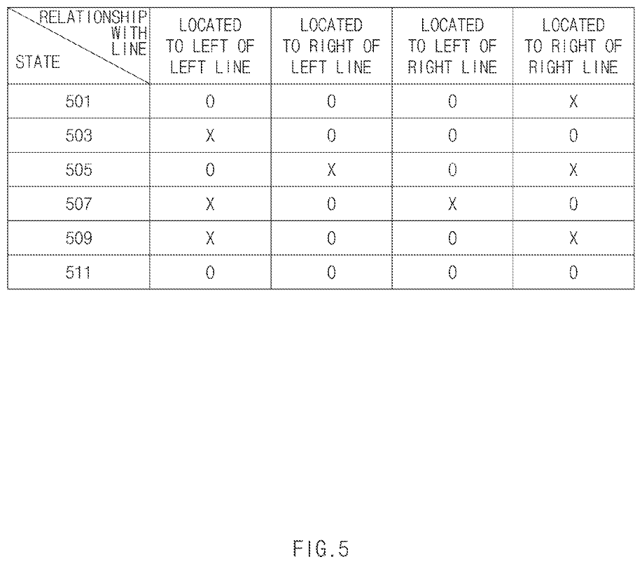

FIG. 5 shows a table showing a state corresponding to the position of a fusion track and a state corresponding to the position of a LIDAR track in an object recognition apparatus or an object recognition method.

Referring to FIG. 5, the processor of the object recognition apparatus may identify a state corresponding to the position of a LIDAR track or a state corresponding to the position of a fusion track as one of a first state 501, a second state 503, a third state 505, a fourth state 507, a fifth state 509, and a sixth state 511. In the table, when a contour point included in the LIDAR track or part of four vertices of a track box representing the fusion track are located on the left or right side of a specific line, a mark indicating correct (e.g., O) is described. In the table, when the contour point or part of the four vertices is not located on the left or right side of the specific line, a mark indicating wrong (e.g., X) is described.

The processor of the object recognition apparatus may identify the state corresponding to the position of the LIDAR track (e.g., the first LIDAR track 405 in FIG. 4) as the first state 501, based on identifying that part of the contour points are located to the left of the left line, that other part of the contour points are located to the right of the left line, and that the contour points are located to the left of the right line.

The processor of the object recognition apparatus may identify the state corresponding to the position of the LIDAR track (e.g., the second LIDAR track 415 in FIG. 4) as the second state 503, based on identifying that the contour points are located to the right of the left line, that part of the contour points are located to the left of the right line, and that other part of the contour points are located to the right of the right line.

The processor of the object recognition apparatus may identify the state corresponding to the position of the LIDAR track (e.g., the third LIDAR track 425 in FIG. 4) as the third state 505, based on identifying that the contour points are located to the left of the left line and that the contour points are located to the left of the right line.

The processor of the object recognition apparatus may identify the state corresponding to the position of the LIDAR track (e.g., the fourth LIDAR track 435 in FIG. 4) as the fourth state 507, based on identifying that the contour points are located to the right of the left line and that the contour points are located to the right of the right line.

The processor of the object recognition apparatus may identify the state corresponding to the position of the LIDAR track (e.g., the fifth LIDAR track 445 in FIG. 4) as the fifth state 509, based on identifying that the contour points are located to the right of the left line and that the contour points are located to the left of the right line.

The processor of the object recognition apparatus may identify the state corresponding to the position of the LIDAR track (e.g., the sixth LIDAR track 455 in FIG. 4) as the sixth state 511, based on identifying that part of the contour points are located to the left of the left line, that other part of the contour points are located to the right of the left line, that part of the contour points are located to the left of the right line, and that other part of the contour points are located to the right of the right line.

The processor of the object recognition apparatus may identify the state corresponding to the position of the fusion track (e.g., the first fusion track 403 in FIG. 4) as the first state 501, based on identifying that part of four vertices of a track box representing a fusion track are located to the left of the left line, that other part of the four vertices are located to the right of the left line, and that the four vertices are located to the left of the right line.

The processor of the object recognition apparatus may identify the state corresponding to the position of the LIDAR track (e.g., the second LIDAR track 413 in FIG. 4) as the second state 503, based on identifying that the four vertices are located to the right of the left line, that part of the four vertices are located to the left of the right line, and that other part of the four vertices are located to the right of the right line.

The processor of the object recognition apparatus may identify a state corresponding to the position of the fusion track (e.g., the third fusion track 423 in FIG. 4) as the third state 505, based on identifying that the four vertices are located to the left of the left line and that the four vertices are located to the left of the right line.

The processor of the object recognition apparatus may identify the state corresponding to the position of the fusion track (e.g., the fourth fusion track 433 in FIG. 4) as the fourth state 507, based on identifying that the four vertices are located to the right of the left line and that the four vertices are located to the right of the right line.

The processor of the object recognition apparatus may identify the state corresponding to the position of the fusion track (e.g., the fifth fusion track 443 in FIG. 4) as the fifth state 509, based on identifying that the four vertices are located to the right of the left line and that the four vertices are located to the left of the right line.

The processor of the object recognition apparatus may identify the state corresponding to the position of the fusion track (e.g., the sixth fusion track 453 in FIG. 4) as the sixth state 511, based on identifying that part of the four vertices are located to the left of the left line, that other part of the four vertices are located to the right of the left line, that part of the four vertices are located to the left of the right line, and that other part of the four vertices are located to the right of the right line.

The processor of the object recognition apparatus may identify a state corresponding to the LIDAR track or a state corresponding to the fusion track based on a third function, which is a function representing a first straight line, a fourth function, which is a function representing a second straight line, and the coordinates of the contour points or the coordinates of the four vertices of a track box representing a fusion track.

The processor of the object recognition apparatus may identify at least one direction in which all or part of the contour points are located among the left and right sides divided by a specific line, based on the signs (e.g., (+), or (−)) of values identified by substituting the coordinates of the contour points into a specific function (e.g., a third function or a fourth function) corresponding to a specific line (e.g., a left line or a right line).

For example, when the sign of a value identified by substituting the coordinates of a specific contour point into a specific function (e.g., a third function or a fourth function) corresponding to a specific line is (+), the specific contour point may be identified as being located to the right of a straight line (e.g., a first straight line or a second straight line) representing the specific line.

For example, when the sign of a value identified by substituting the coordinates of a specific contour point into a specific function (e.g., a third function or a fourth function) corresponding to a specific line is (−), the specific contour point may be identified as being located to the left of a straight line (e.g., a first straight line or a second straight line) representing the specific line.

The processor of the object recognition apparatus may identify at least one direction in which all or part of four vertices are located among the left and right sides divided by a specific line, based on the signs (e.g., (+), or (−)) of values identified by substituting the coordinates of the four vertices of a track box representing a fusion track into a specific function (e.g., a third function or a fourth function) corresponding to a specific line (e.g., a left line or a right line).

For example, when the sign of a value identified by substituting the coordinates of a specific vertex of the four vertices into a specific function (e.g., a third function or a fourth function) corresponding to a specific line is (+), the specific vertex may be identified as being located to the right of a straight line (e.g., a first straight line or a second straight line) representing the specific line.

For example, when the sign of a value identified by substituting the coordinates of a specific vertex of the four vertices into a specific function (e.g., a third function or a fourth function) corresponding to a specific line is (−), the specific vertex may be identified as being located to the left of a straight line (e.g., a first straight line or a second straight line) representing the specific line.

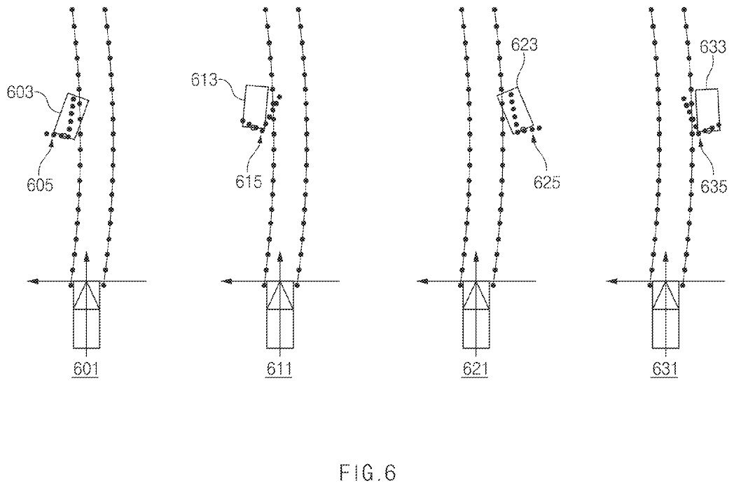

FIG. 6 shows a case in which a state corresponding to the position of a fusion track does not match a state corresponding to the position of a LIDAR track in an object recognition apparatus or an object recognition method.

Referring to FIG. 6, in a first situation 601, a state corresponding to the position of a first LIDAR track 605 may be the third state, and a state corresponding to the position of a first fusion track 603 may be the first state.

In a second situation 611, a state corresponding to the position of a second LIDAR track 615 may be the first state, and a state corresponding to the position of a second fusion track 613 may be the third state.

In a third situation 621, a state corresponding to the position of a third LIDAR track 625 may be the fourth state, and a state corresponding to the position of a third fusion track 623 may be the second state.

In a fourth situation 631, a state corresponding to the position of a fourth LIDAR track 635 may be the second state, and a state corresponding to the position of a fourth fusion track 633 may be the fourth state.

A state corresponding to the position of a LIDAR track (e.g., the first LIDAR track 605, the second LIDAR track 615, the third LIDAR track 625, or the fourth LIDAR track 635) may not match a state corresponding to the position of a fusion track (e.g., the first fusion track 603, the second fusion track 613, the third fusion track 623, or the fourth fusion track 633). Because the accuracy of the position of the LIDAR track may be higher than the accuracy of the position of the fusion track, the processor of the object recognition apparatus may change the lateral position of the fusion track based on the lateral position of the LIDAR track.

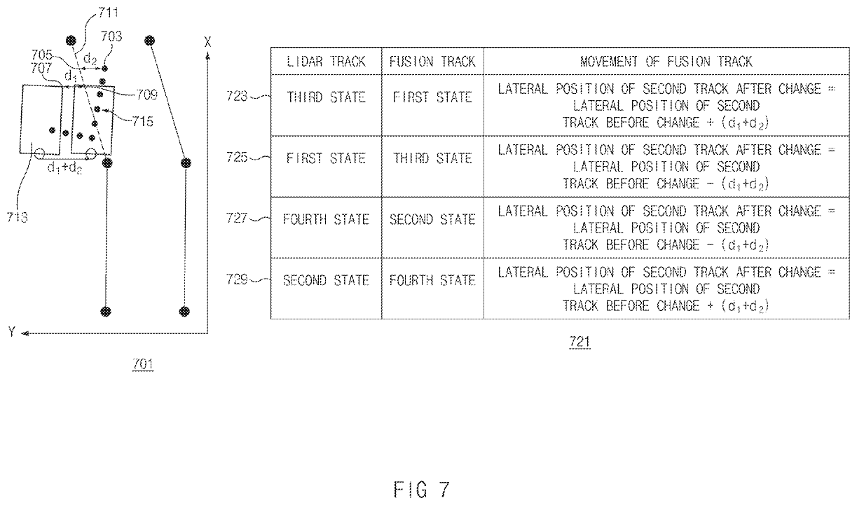

FIG. 7 shows an example of a distance a fusion track has moved in an object recognition apparatus or an object recognition method.

Referring to FIG. 7, in situation 701, a LIDAR track 715 may represent an external object. A fusion track 713 may represent the external object represented by the LIDAR track 715. A right contour point 703 may represent the rightmost point among contour points included in the LIDAR track 715. A right vertex 707 may represent the rightmost vertex among the four vertices of the track box representing the fusion track 713. A first straight line 711 may represent the left line of a host vehicle. A fifth point 709 may be located on the first straight line 711. The longitudinal coordinate of the fifth point 709 may be the same as the longitudinal coordinates of the right vertex 707. A sixth point 705 may be located on the first straight line 711. The longitudinal coordinate of the sixth point 705 may be the same as the longitudinal coordinate of the right contour point 703.

In a table 721, the movement direction of a fusion track identified according to the combination of the state corresponding to the position of a LIDAR track and the state corresponding to the position of a fusion track, and a specified distance are described. In a first combination 723, the state corresponding to the position of the LIDAR track may be the third state, and the state corresponding to the position of the fusion track may be the first state. In a second combination 725, the state corresponding to the position of the LIDAR track may be the first state, and the state corresponding to the position of the fusion track may be the third state. In a third combination 727, the state corresponding to the position of the LIDAR track may be the fourth state, and the state corresponding to the position of the fusion track may be the second state. In a fourth combination 729, the state corresponding to the position of the LIDAR track may be the second state, and the state corresponding to the position of the fusion track may be the fourth state.

In the situation 701, the state corresponding to the position of the LIDAR track 715 may be the first state, and the state corresponding to the position of the fusion track 713 may be the third state. In other words, in the situation 701, the second combination 725 may be identified. Accordingly, the state corresponding to the position of the LIDAR track 715 with respect to the left line may not match the state corresponding to the position of the fusion track 713 with respect to the left line.

If the state corresponding to the position of the LIDAR track 715 with respect to the left line does not match the state corresponding to the position of the fusion track 713 with respect to the left line, the processor of the object recognition apparatus may identify a first distance (e.g., d1) between the fifth point 709 located on the first straight line 711 and the right vertex 707. The processor of the object recognition apparatus may identify a second distance (e.g., d2) between the sixth point 705 located on the first straight line 711 and the right contour point 703. The processor of the object recognition apparatus may move the fusion track 713 by a distance (e.g., d1+d2) identified based on the sum of the first distance and the second distance in a direction identified based on the state corresponding to the position of the LIDAR track 715 and the state corresponding to the position of the fusion track 713. The direction identified based on the state corresponding to the position of the LIDAR track 715 and the state corresponding to the position of the fusion track 713 may be a direction closer to the left line in the lateral direction (e.g., (−) y direction).

In the first combination 723, the state corresponding to the position of the LIDAR track may be the third state, and the state corresponding to the position of the fusion track may be the first state.

When the state corresponding to the position of the LIDAR track with respect to the left line does not match the state corresponding to the position of the fusion track with respect to the left line, the processor of the object recognition apparatus may move the fusion track by an identified distance in a direction identified based on the first combination 723.

In the first combination 723, the identified direction may be a direction away from the left line (e.g., (+) y direction). Like the second combination 725 in the situation 701, a distance identified based on the first combination 723 may be identified as the sum of the first distance between the fifth point and the right vertex and the second distance between the sixth point and the right contour point.

In the third combination 727, the state corresponding to the position of the LIDAR track may be the fourth state, and the state corresponding to the position of the fusion track may be the second state. Therefore, the state corresponding to the position of the LIDAR track with respect to the right line may not match the state corresponding to the position of the fusion track with respect to the right line.

When the state corresponding to the position of the LIDAR track with respect to the left line does not match the state corresponding to the position of the fusion track with respect to the left line, the processor of the object recognition apparatus may identify a third distance between a seventh point located on the second straight line representing the right line and the left vertex. The left vertex may include the leftmost vertex of the four vertices of the track box representing the fusion track. The processor of the object recognition apparatus may identify a fourth distance between an eighth point located on the second straight line and the left contour point. The left contour point may include the leftmost contour point of the contour points. The processor of the object recognition apparatus may move the fusion track in the direction identified based on the third combination 727 by a distance identified based on the sum of the third distance and the fourth distance. The direction identified based on the third combination 727 may be a direction moving laterally away from the right line (e.g., (−) y direction).

In the fourth combination 729, the state corresponding to the position of the LIDAR track may be the second state, and the state corresponding to the position of the fusion track may be the fourth state. Therefore, the state corresponding to the position of the LIDAR track with respect to the right line may not match the state corresponding to the position of the fusion track with respect to the right line.

When the state corresponding to the position of the LIDAR track with respect to the right line does not match the state corresponding to the position of the fusion track with respect to the right line, the processor of the object recognition apparatus may move the fusion track by an identified distance in a direction identified based on the fourth combination 729.

In the fourth combination 729, the identified direction may be a direction (e.g., (+) y direction) closer to the right line in the lateral direction. Like the third combination 727, the distance identified based on the fourth combination 729 may be identified as being the sum of the third distance between the seventh point and the left vertex and the fourth distance between the eighth point and the left contour point.

The longitudinal coordinate of the seventh point may be the same as the longitudinal coordinate of the left vertex, and the longitudinal coordinate of the eighth point may be the same as the longitudinal coordinate of the left contour point.

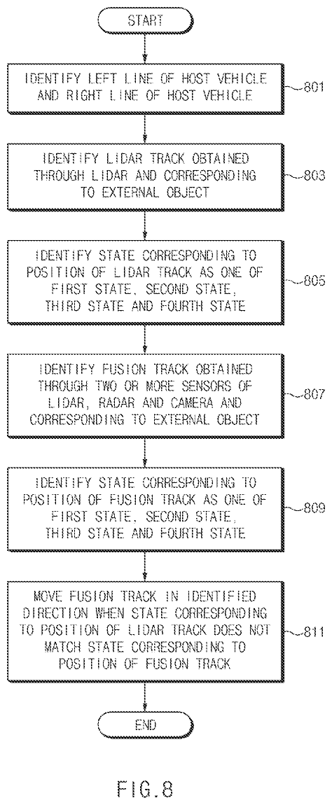

FIG. 8 shows a flowchart of operation of an object recognition apparatus for moving a fusion track in the object recognition apparatus or the object recognition method according to an embodiment of the present disclosure.

Hereinafter, it is assumed that the object recognition apparatus 101 of FIG. 1 performs the process of FIG. 8. Additionally, in the description of FIG. 8, operations described as being performed by the object recognition apparatus may be understood as being controlled by the processor 109 of the object recognition apparatus 101.

Referring to FIG. 8, in a first operation 801, the processor of the object recognition apparatus may identify the left line of a host vehicle and the right line of the host vehicle.

In a second operation 803, the processor of the object recognition apparatus may identify a LIDAR track obtained through a LIDAR and corresponding to an external object.

In a third operation 805, the processor of the object recognition apparatus may identify a state corresponding to the position of the LIDAR track as one of a first state, a second state, a third state, and a fourth state. A state corresponding to the position of the LIDAR track with respect to the left or right line may be identified based on contour points representing the LIDAR track.

In a fourth operation 807, the processor of the object recognition apparatus may identify a fusion track obtained through at least two sensors among a LIDAR, a radar, and a camera and corresponding to an external object.

In a fifth operation 809, the processor of the object recognition apparatus may identify a state corresponding to the position of the fusion track as one of the first state, the second state, the third state, and the fourth state. A state corresponding to the position of the fusion track with respect to the left or right line may be identified based on a track box representing the fusion track.

In a sixth operation 811, when the state corresponding to the position of the LIDAR track does not match the state corresponding to the position of the fusion track, the processor of the object recognition apparatus may move the fusion track in an identified direction. The direction in which the fusion track moves may be identified based on at least one of a state corresponding to the position of the LIDAR track, or a state corresponding to the position of the fusion track, or any combination thereof.

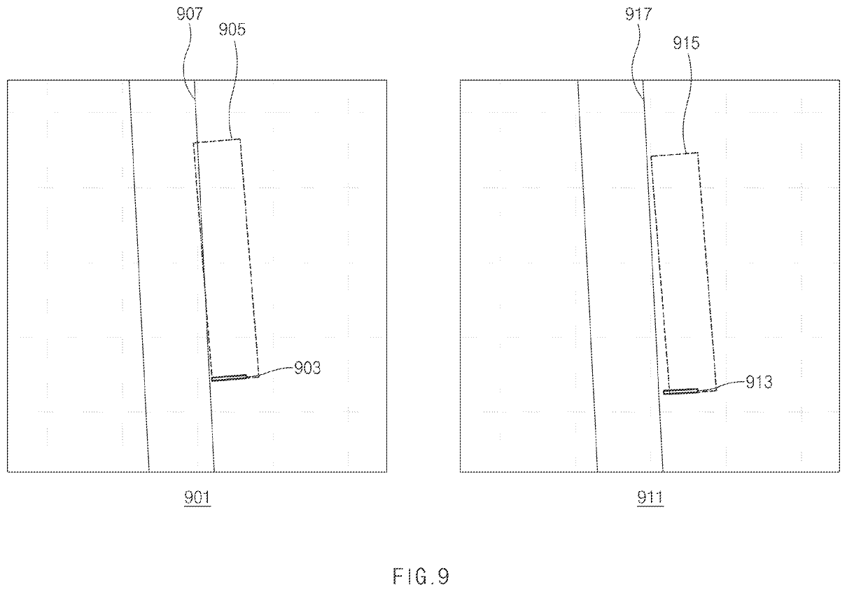

FIG. 9 shows an example of accuracy improvement performed based on movement of a fusion track in an object recognition apparatus or an object recognition method.

Referring to FIG. 9, a first screen 901 may include a LIDAR track 903, a fusion track 905, and a right line 907 identified according to an existing object recognition apparatus. The LIDAR track 903 and the fusion track 905 may represent the same external object. A second screen 911 may include a LIDAR track 913, a fusion track 915, and a right line 917 identified according to an object recognition apparatus. The LIDAR track 913 and the fusion track 915 may represent the same external object.

In the first screen 901, the LIDAR track 903 may be located on the right side of the right line 907. The LIDAR track 903 may not intrude on the own lane where a host vehicle is located. The fusion track 905 may intrude on the right line 907. The fusion track 905 may intrude on the own lane.

The accuracy of the position of the fusion track 905 may be lower than the accuracy of the position of the LIDAR track 903. Accordingly, there may be a high probability that an external object corresponding to the fusion track 905 and the LIDAR track 903 does not actually intrude on the own lane. However, the existing object recognition apparatus may erroneously brake the host vehicle because the fusion track 905 intrudes on the right line 907.

In the second screen 911, the LIDAR track 913 may be located on the right side of the right line 917. The LIDAR track 913 may not intrude on the own lane where the host vehicle is located. The fusion track 915 may not intrude on the right line 917 by correcting the lateral position of the fusion track of the present disclosure. Therefore, the fusion track 915 may not intrude on the own lane.

The object recognition apparatus may not erroneously brake the host vehicle because the fusion track 915 does not intrude on the right line 917.

When the fusion track does not intrude on the own lane and the LIDAR track intrudes on the own lane, the object recognition apparatus may identify that the fusion track has intruded on the own lane by correcting the position of the fusion track to prevent non-braking.

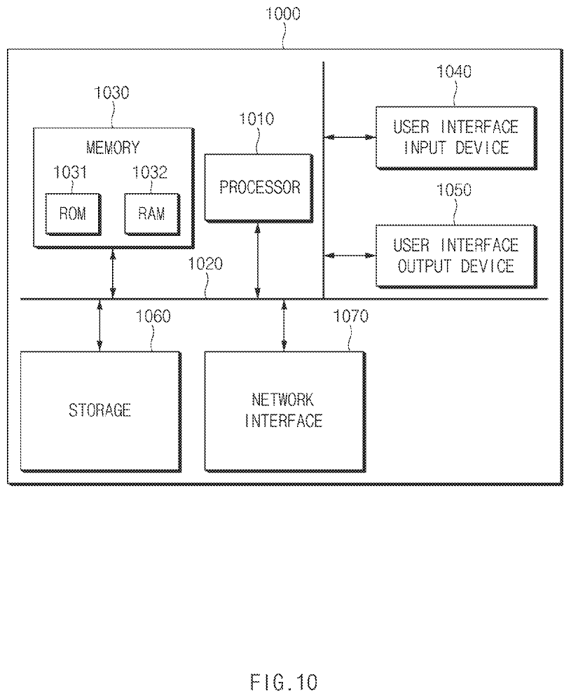

FIG. 10 shows a computing system related to an object recognition apparatus and an object recognition method.

Referring to FIG. 10, a computing system 1000 may include at least one processor 1010, a memory 1030, a user interface input device 1040, a user interface output device 1050, storage 1060, and a network interface 1070, which are connected with each other via a bus 1020.

The processor 1010 may be a central processing unit (CPU) or a semiconductor device that processes instructions stored in the memory 1030 and/or the storage 1060. The memory 1030 and the storage 1060 may include various types of volatile or non-volatile storage media. For example, the memory 1030 may include a ROM (Read Only Memory) 1031 and a RAM (Random Access Memory) 1032.

Thus, the operations of the method or the algorithm described in connection with the one or more example embodiments disclosed herein may be embodied directly in hardware or a software module executed by the processor 1010, or in a combination thereof. The software module may reside on a storage medium (that is, the memory 1030 and/or the storage 1060) such as a RAM, a flash memory, a ROM, an EPROM, an EEPROM, a register, a hard disk, a removable disk, and a CD-ROM.

The exemplary storage medium may be coupled to the processor 1010, and the processor 1010 may read information out of the storage medium and may record information in the storage medium. Alternatively, the storage medium may be integrated with the processor 1010. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiments disclosed in the present disclosure are not intended to limit the technical idea of the present disclosure but to describe the present disclosure, and the scope of the technical idea of the present disclosure is not limited by the example embodiments. The scope of protection of the present disclosure should be interpreted by the following claims, and all technical ideas within the scope equivalent thereto should be construed as being included in the scope of the present disclosure.

The present technology may identify a LIDAR point corresponding to a target fusion track identified through at least one sensor.

Further, the present technology may increase the accuracy of the position of an external object corresponding to a target fusion track identified through at least one sensor.

Further, the present technology may reduce the frequency of false braking of an autonomous vehicle or a vehicle with activated driver assistance devices by increasing the accuracy of the position of an external object corresponding to a target fusion track identified through at least one sensor.

Further, the present technology may reduce the frequency of misrecognition of the category of a target fusion track by increasing the accuracy of the position of an external object corresponding to a target fusion track identified through at least one sensor.

In addition, various effects may be provided that are directly or indirectly understood through the disclosure.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a camera;
a light detection and ranging device (LIDAR);
a radar; and
a processor configured to:
determine a left line and a right line of a lane on which a vehicle is located;
obtain, via the LIDAR, a LIDAR track corresponding to an external object;
determine, based on contour points representing the LIDAR track, a LIDAR track state, which corresponds to a position of the LIDAR track relative to one of the left line or the right line, as one of a first state, a second state, a third state, or a fourth state;
obtain, via at least two of the LIDAR, the radar, and the camera, a fusion track corresponding to the external object;
determine, based on a track box representing the fusion track, a fusion track state, which corresponds to a position of the fusion track relative to one of the left line or the right line, as one of the first state, the second state, the third state, or the fourth state;
move, based on the LIDAR track state not matching the fusion track state, the fusion track in a direction determined based on at least one of the LIDAR track state or the fusion track state; and
output a signal indicating the moved fusion track.

2. The apparatus of claim 1, wherein the processor is further configured to:
determine a first descriptor representing the left line and a second descriptor representing the right line; and
determine a first point and a second point on the left line according to the LIDAR track and determine a third point and a fourth point on the right line according to the LIDAR track, wherein the first point, the second point, the third point, and the fourth point are determined based on:
a longitudinal coordinate of a first contour point that is farthest, among the contour points representing the LIDAR track, from the vehicle in a longitudinal direction,
a longitudinal coordinate of a second contour point that is closest, among the contour points representing the LIDAR track, to the vehicle in the longitudinal direction,
the first descriptor,
the second descriptor, and
a specified distance,
wherein the processor is configured to determine the LIDAR track state by determining the LIDAR track state based on at least one of a first straight line connecting the first point and the second point, a second straight line connecting the third point and the fourth point, or coordinates of the contour points, and
wherein the processor is configured to determine the fusion track state by determining the fusion track state based on at least one of the first straight line, the second straight line, or coordinates of four vertices of the track box.

3. The apparatus of claim 2, wherein the first point comprises:
a longitudinal coordinate that is farther from the vehicle among two longitudinal coordinates separated by the specified distance in the longitudinal direction from a longitudinal coordinate representing an average of the longitudinal coordinate of the first contour point and the longitudinal coordinate of the second contour point, and
a lateral coordinate determined by applying the longitudinal coordinate farther from the vehicle into the first descriptor,
wherein the second point comprises:
a longitudinal coordinate that is closer to the vehicle among the two longitudinal coordinates, and
a lateral coordinate determined by applying the longitudinal coordinate that is closer to the vehicle into the first descriptor,
wherein the third point comprises:
the longitudinal coordinate that is farther from the vehicle among the two longitudinal coordinates, and
a lateral coordinate determined by applying the longitudinal coordinate that is farther from the vehicle into the second descriptor, and
wherein the fourth point comprises:
the longitudinal coordinate that is closer to the vehicle among the two longitudinal coordinates, and
a lateral coordinate determined by applying the longitudinal coordinate that is closer to the vehicle into the second descriptor.

4. The apparatus of claim 2, wherein the processor is configured to determine the LIDAR track state by:
determining the LIDAR track state further based on at least one of:
at least one direction in which at least part of the contour points are located among a left side and a right side divided by the first straight line, or
at least one direction in which at least part of the contour points are located among a left side and a right side divided by the second straight line, and
wherein the processor is configured to determine the fusion track state by:
determining the fusion track state based on at least one of:
at least one direction in which at least part of the four vertices are located among the left side and the right side divided by the first straight line, or
at least one direction in which at least part of the four vertices are located among the left side and the right side divided by the second straight line.

5. The apparatus of claim 2, wherein the processor is further configured to:
determine a third descriptor representing the first straight line and a fourth descriptor representing the second straight line,
wherein the processor is configured to determine the LIDAR track state by determining the LIDAR track state based on at least one of:
a first direction includes at least one direction in which at least part of the contour points are located among left and right sides separated by the left line, wherein the first direction is determined based on signs of values determined by applying the coordinates of the contour points into the third descriptor, and
a second direction includes at least one direction in which at least part of the contour points are located among left and right sides separated by the right line, wherein the second direction is determined based on signs of values determined by applying the coordinates of the contour points into the fourth descriptor, and
wherein the processor is configured to determine the fusion track state by determining the fusion track state based on at least one of:
a third direction includes at least one direction in which at least part of the four vertices are located among left and right sides separated by the left line, wherein the third direction is determined based on signs of values determined by applying the coordinates of the four vertices into the third descriptor, and
a fourth direction includes at least one direction in which at least part of the four vertices are located among left and right sides separated by the right line, wherein the fourth direction is determined based on signs of values determined by applying the coordinates of the four vertices into the fourth descriptor.

6. The apparatus of claim 2, wherein the processor is configured to move the fusion track by, based on the LIDAR track state corresponding to the position of the LIDAR track relative to the left line not matching the fusion track state corresponding to the position of the fusion track relative to the left line:
determining a first distance between a fifth point located on the first straight line and a rightmost vertex of the four vertices;
determining a second distance between a sixth point located on the first straight line and a rightmost contour point among the contour points; and
moving the fusion track by a sum of the first distance and the second distance,
wherein a longitudinal coordinate of the fifth point is identical to a longitudinal coordinate of the rightmost vertex, and
wherein a longitudinal coordinate of the sixth point is identical to a longitudinal coordinate of the rightmost contour point.

7. The apparatus of claim 2, wherein the processor is configured to move the fusion track by, based on the LIDAR track state corresponding to the position of the LIDAR track relative to the right line not matching the fusion track state corresponding to the position of the fusion track relative to the right line:
determining a third distance between a seventh point located on the second straight line and a leftmost vertex of the four vertices;
determining a fourth distance between an eighth point located on the second straight line and a leftmost contour point among the contour points; and
moving the fusion track by a sum of the third distance and the fourth distance,
wherein a longitudinal coordinate of the seventh point is identical to a longitudinal coordinate of the leftmost vertex, and
wherein a longitudinal coordinate of the eighth point is identical to a longitudinal coordinate of the leftmost contour point.

8. The apparatus of claim 1, wherein the processor is configured to determine the LIDAR track state by performing one of: determining the LIDAR track state to be the first state based on determining that part of the contour points are located to left of the left line, other part of the contour points are located to right of the left line, and the contour points are located to left of the right line;
determining the LIDAR track state to be the second state based on determining that the contour points are located to right of the left line, part of the contour points are located to left of the right line, other part of the contour points are located to right of the right line;
determining the LIDAR track state to be the third state based on determining that the contour points are located to left of the left line and the contour points are located to left of the right line; or
determining the LIDAR track state to be the fourth state based on determining that the contour points are located to right of the left line and the contour points are located to right of the right line.

9. The apparatus of claim 2, wherein the processor is configured to determine the fusion track state by performing one of:
determining the fusion track state to be the first state based on identifying that part of the four vertices are located to left of the left line, other part of the four vertices are located to right of the left line, and the four vertices are located to left of the right line;
determining the fusion track state to be the second state based on identifying that the four vertices are located to right of the left line, part of the four vertices are located to left of the right line, and other part of the four vertices are located to right of the right line;
determining the fusion track state to be the third state based on identifying that the four vertices are located to left of the left line and the four vertices are located to left of the right line; or
determining the fusion track state to be the fourth state based on identifying that the four vertices are located to right of the left line and the four vertices are located to right of the right line.

10. The apparatus of claim 4, wherein the processor is further configured to perform at least one of:
determining the LIDAR track state to be a fifth state based on determining that the contour points are located to right of the left line and the contour points are located to left of the right line;
determining the LIDAR track state to be a sixth state based on determining that part of the contour points are located to left of the left line, other part of the contour points are located to right of the left line, part of the contour points are located to left of the right line, and other part of the contour points are located to right of the right line;
determining the fusion track state to be the fifth state based on identifying that the four vertices are located to right of the left line and the four vertices are located to left of the right line; or
determining the fusion track state to be the sixth state based on determining that part of the four vertices are located to left of the left line, other part of the four vertices are located to right of the left line, part of the four vertices are located to left of the right line, and other part of the four vertices are located to right of the right line.

11. The apparatus of claim 1, wherein the processor is further configured to perform one of:
moving, based on the LIDAR track state being the first state and the fusion track state being the third state, the fusion track in a direction closer to the left line by a first distance determined based on at least one of a rightmost vertex among four vertices of the track box, or a rightmost contour point of the contour points; and
moving, based on the LIDAR track state being the third state and the fusion track state being the first state, the fusion track in a direction away from the left line by the first distance.

12. The apparatus of claim 1, wherein the processor is further configured to perform one of:
moving the fusion track in a direction closer to the right line by a first distance determined based on at least one of a leftmost vertex of four vertices of the track box, or a leftmost contour point of the contour points, based on the LIDAR track state being the second state and the fusion track state being the fourth state; and
moving the fusion track in a direction away from the right line by the first distance based on the LIDAR track state being the fourth state and the fusion track state being the second state.

13. The apparatus of claim 2, wherein the processor is configured to perform one of:
determining, based on a portion of an image obtained through the camera, at least one of the first descriptor or the second descriptor; or
determining, based on at least one of a yaw rate of the vehicle or a steering angle sensor angle, at least one of the first descriptor or the second descriptor.

14. A method performed by a processor, the method comprising:
determining a left line and a right line of a lane on which a vehicle is located;
obtaining, via a light detection and ranging device (LIDAR), a LIDAR track corresponding to an external object;
determining, based on contour points representing the LIDAR track, a LIDAR track state, which corresponds to a position of the LIDAR track relative to one of the left line or the right line, as one of a first state, a second state, a third state, or a fourth state;
obtaining, via at least two of the LIDAR, a radar, and a camera, a fusion track corresponding to the external object;
determining, based on a track box representing the fusion track, a fusion track state, which corresponds to a position of the fusion track relative to one of the left line or the right line, as one of the first state, the second state, the third state, or the fourth state;
moving, based on the LIDAR track state not matching the fusion track state, the fusion track in a direction determined based on at least one of the LIDAR track state or the fusion track state; and
outputting a signal indicating the moved fusion track.

15. The method of claim 14, further comprising determining a first descriptor representing the left line and a second descriptor representing the right line,
wherein the determining of the LIDAR track state comprises:
determining a first point and a second point on the left line according to the LIDAR track and determining a third point and a fourth point on the right line according to the LIDAR track, wherein the determining of the first point, the second point, the third point, and the fourth point is based on:
a longitudinal coordinate of a first contour point that is farthest, among the contour points representing the LIDAR track, from the vehicle in a longitudinal direction,
a longitudinal coordinate of a second contour point that is closest, among the contour points representing the LIDAR track, to the vehicle in the longitudinal direction,
the first descriptor,
the second descriptor, and
a specified distance; and
determining the LIDAR track state based on at least one of a first straight line connecting the first point and the second point, a second straight line connecting the third point and the fourth point, or coordinates of the contour points, and
wherein the determining of the fusion track state comprises determining of the fusion track state based on at least one of the first straight line, the second straight line, or coordinates of four vertices of the track box.

16. The method of claim 15, wherein the first point comprises:
a longitudinal coordinate that is farther from the vehicle among two longitudinal coordinates separated by the specified distance in the longitudinal direction from a longitudinal coordinate representing an average of the longitudinal coordinate of the first contour point and the longitudinal coordinate of the second contour point, and
a lateral coordinate determined by applying the longitudinal coordinate farther from the vehicle into the first descriptor,
wherein the second point comprises:
a longitudinal coordinate that is closer to the vehicle among the two longitudinal coordinates, and
a lateral coordinate determined by applying the longitudinal coordinate that is closer to the vehicle into the first descriptor,
wherein the third point comprises:
the longitudinal coordinate that is farther from the vehicle among the two longitudinal coordinates, and
a lateral coordinate determined by applying the longitudinal coordinate that is farther from the vehicle into the second descriptor, and
wherein the fourth point comprises:
the longitudinal coordinate that is closer to the vehicle among the two longitudinal coordinates, and
a lateral coordinate determined by applying the longitudinal coordinate that is closer to the vehicle into the second descriptor.

17. The method of claim 15, wherein the determining of the LIDAR track state comprises:
determining the LIDAR track state further based on at least one of:
at least one direction in which at least part of the contour points are located among a left side and a right side divided by the first straight line, or
at least one direction in which at least part of the contour points are located among a left side and a right side divided by the second straight line, and
wherein the determining of the fusion track state comprises:
determining the fusion track state based on at least one of:
at least one direction in which at least part of the four vertices are located among the left side and the right side divided by the first straight line, or
at least one direction in which at least part of the four vertices are located among the left side and the right side divided by the second straight line.

18. The method of claim 15, further comprising:
determining a third descriptor representing the first straight line and a fourth descriptor representing the second straight line,
wherein the determining of the LIDAR track state comprises determining the LIDAR track state based on at least one of:
a first direction includes at least one direction in which at least part of the contour points are located among left and right sides separated by the left line, wherein the first direction is determined based on signs of values determined by applying the coordinates of the contour points into the third descriptor, and
a second direction includes at least one direction in which at least part of the contour points are located among left and right sides separated by the right line, wherein the second direction is determined based on signs of values determined by applying the coordinates of the contour points into the fourth descriptor, and
wherein the determining of the fusion track state comprises determining the fusion track state based on at least one of:
a third direction includes at least one direction in which at least part of the four vertices are located among left and right sides separated by the left line, wherein the third direction is determined based on signs of values determined by applying the coordinates of the four vertices into the third descriptor, and
a fourth direction includes at least one direction in which at least part of the four vertices are located among left and right sides separated by the right line, wherein the fourth direction is determined based on signs of values determined by applying the coordinates of the four vertices into the fourth descriptor.

19. The method of claim 15, wherein the moving of the fusion track comprises, based on the LIDAR track state corresponding to the position of the LIDAR track relative to the left line not matching the fusion track state corresponding to the position of the fusion track relative to the left line:
determining a first distance between a fifth point located on the first straight line and a rightmost vertex of the four vertices;
determining a second distance between a sixth point located on the first straight line and a rightmost contour point among the contour points; and
moving the fusion track by a sum of the first distance and the second distance,
wherein a longitudinal coordinate of the fifth point is identical to a longitudinal coordinate of the rightmost vertex, and
wherein a longitudinal coordinate of the sixth point is identical to a longitudinal coordinate of the rightmost contour point.

20. The method of claim 15, wherein the moving of the fusion track comprises, based on the LIDAR track state corresponding to the position of the LIDAR track with respect to the right line not matching the fusion track state corresponding to the position of the fusion track relative to the right line:
determining a third distance between a seventh point located on the second straight line and a leftmost vertex of the four vertices;
determining a fourth distance between an eighth point located on the second straight line and a leftmost contour point among the contour points; and
moving the fusion track by a sum of the third distance and the fourth distance,
wherein a longitudinal coordinate of the seventh point is identical to a longitudinal coordinate of the leftmost vertex, and
wherein a longitudinal coordinate of the eighth point is identical to a longitudinal coordinate of the leftmost contour point.
